(19) United States
(12) Patent Application Publication
(10) Pub. No.: US 2013/0246835 A1
(43) Pub. Date: Sep. 19, 2013

(54) SLEEP CLOCK SLEW COMPENSATION

(71) Applicants: Amit Mahajan, San Diego, CA (US); Gregory Robert Lie, San Diego, CA (US); Insung Kang, San Diego, CA (US)

(72) Inventors: Amit Mahajan, San Diego, CA (US); Gregory Robert Lie, San Diego, CA (US); Insung Kang, San Diego, CA (US)

(73) Assignee: QUALCOMM INCORPORATED, San Diego, CA (US)

(21) Appl. No.: 13/605,953

(22) Filed: Sep. 6, 2012

Related U.S. Application Data
(60) Provisional application No. 61/532,009, filed on Sep. 7, 2011.

(51) Int. Cl. G06F 1/10

(52) U.S. Cl. CPC G06F 1/10
USPC 713/503

(57) ABSTRACT

A method for compensating for sleep clock slew is disclosed. The method may conserve battery power. The method includes operating in a discontinuous receive mode. A measured sleep clock slew is determined. Discontinuous receive mode parameters are adjusted based on the measured sleep clock slew. Discontinuous receive mode wake-up procedures are performed. The discontinuous receive mode parameters may include a sleep time and a search time. Other aspects, embodiments, and features are also claimed and described.

### RELATED APPLICATION AND PRIORITY CLAIM

This application is related to and claims priority from U.S. Provisional Patent Application Ser. No. 61/532,009, filed Sep. 7, 2011, for “DYNAMIC SLEEP TIMELINE AND SEARCH PARAMETERS TO AVOID SYSTEM LOSSES DUE TO LARGE SLEEP CLOCK SLEWS,” which is incorporated herein by reference as if fully set forth below and for all applicable purposes.

### TECHNICAL FIELD

The present disclosure relates generally to wireless communication systems. More specifically, the present disclosure relates to systems and methods for sleep clock slew compensation.

### BACKGROUND

Wireless communication systems are widely deployed to provide various types of communication content such as voice, video, data and so on. These systems may be multiple-access systems capable of supporting simultaneous communication of multiple mobile devices with one or more base stations.

Mobile devices are typically battery operated. It is desirable to maximize the battery life of mobile devices. One way to maximize battery life is to shut off components within the mobile device during periods when those components are not needed/used. By shutting off these components, battery power is conserved without reducing the overall user experience of the mobile device. One example of a component that is shut off is the clock generator. Instead of using the clock generator, a simpler sleep clock may be used. The sleep clock may not have the same accuracy as the clock generator but the sleep clock may use considerably less power than the clock generator.

By using a sleep clock, the battery life of mobile devices may be extended. However, using a sleep clock may have drawbacks. For example, since a sleep clock is typically less accurate than a clock generator, the sleep clock may become desynchronized from the clock signal of the network (referred to as clock slew). Clock slew may result in the mobile device losing connection with the network. Benefits may be realized by improvements to mobile devices that use sleep clocks.

### SUMMARY OF SOME EXAMPLE EMBODIMENTS

A method for compensating for sleep clock slew is described. The method includes operating in a discontinuous receive mode. A measured sleep clock slew is determined. Discontinuous receive mode parameters are adjusted based on the measured sleep clock slew. Discontinuous receive mode wake-up procedures are performed.

The discontinuous receive mode parameters may include a sleep time for discontinuous receive mode. The discontinuous receive mode parameters may also include a search time for discontinuous receive mode. It may be determined whether the measured sleep clock slew is greater than a sleep clock slew high threshold.

The sleep clock slew high threshold may be a search time divided by four. If it is determined that the measured sleep clock slew is not greater than the sleep clock slew high threshold, it may be determined whether the measured sleep clock slew is less than a sleep clock slew low threshold. The sleep clock slew low threshold may be a search time divided by eight.

If it is determined that the measured sleep clock slew is less than the sleep clock slew low threshold, it may be determined whether there is a need to increase a sleep time. If it is determined that there is a need to increase the sleep time, adjusting discontinuous receive mode parameters may include increasing the sleep time. The sleep time may be increased by a factor of two.

If it is determined that there is not a need to increase the sleep time, it may be determined whether there is a need to decrease a search time. If there is a need to decrease the search time, adjusting discontinuous receive mode parameters may include decreasing the search time. The search time may be decreased by a factor of two.

If it is determined that the measured sleep clock slew is greater than the sleep clock slew high threshold, it may be determined whether increasing the search time for all reacquire search dispatches is possible. If it is determined that increasing the search time for all reacquire search dispatches is possible, adjusting discontinuous receive mode parameters may include increasing the search time. The search time may be increased by a factor of two.

If it is determined that increasing the search time for all reacquire search dispatches is not possible, it may be determined whether decreasing the sleep time is possible. If it is determined that increasing the sleep time is possible, adjusting discontinuous receive mode parameters may include increasing the sleep time. The sleep time may be increased by a factor of two. If it is determined that increasing the sleep time is not possible, a slow clock frequency estimate may be performed. The method may be performed by a wireless communication device.

An apparatus configured for compensating for sleep clock slew is also described. The apparatus includes a processor, memory in electronic communication with the processor, and instructions stored in the memory. The instructions are executable by the processor to operate in a discontinuous receive mode. The instructions are also executable by the processor to determine a measured sleep clock slew. The instructions are further executable by the processor to adjust discontinuous receive mode parameters based on the measured sleep clock slew. The instructions are also executable by the processor to perform discontinuous receive mode wake-up procedures.

A wireless device configured for compensating for sleep clock slew is described. The wireless device includes means for operating in a discontinuous receive mode. The wireless device also includes means for determining a measured sleep clock slew. The wireless device further includes means for adjusting discontinuous receive mode parameters based on the measured sleep clock slew. The wireless device also includes means for performing discontinuous receive mode wake-up procedures.

A computer-program product configured for compensating for sleep clock slew is also described. The computer-program product includes a non-transitory computer-readable medium having instructions thereon. The instructions include code for causing a wireless device to operate in a discontinuous receive mode. The instructions also include code for causing the wireless device to determine a measured sleep clock slew. The instructions further include code for causing the wireless device to adjust discontinuous receive mode parameters based on the measured sleep clock slew. The instructions also include code for causing the wireless device to perform discontinuous receive mode wake-up procedures.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments, it should be understood that such exemplary embodiments can be implemented in various devices, systems, and methods.

### BRIEF DESCRIPTION OF THE DRAWINGS

FIG. 1 shows a wireless communication system with multiple wireless devices;

FIG. 2 is a flow diagram of a method of compensating for sleep clock slew in DRX mode;

FIG. 3 is a flow diagram of another method of compensating for sleep clock slew in DRX mode;

FIG. 4 shows a timing diagram of DRX wake-up procedures for a wireless communication device when the search time is increased;

FIG. 5 shows a timing diagram of DRX wake-up procedures for a wireless communication device when the sleep time is decreased;

FIG. 6 shows a timing diagram of DRX wake-up procedures for a wireless communication device when the sleep time is increased;

FIG. 7 shows a timing diagram of DRX wake-up procedures for a wireless communication device when the search time is decreased;

FIG. 8 is a flow diagram of yet another method of compensating for sleep clock slew in DRX mode; and

FIG. 9 illustrates certain components that may be included within a wireless communication device.

### DETAILED DESCRIPTION OF ALTERNATIVE & EXEMPLARY EMBODIMENTS

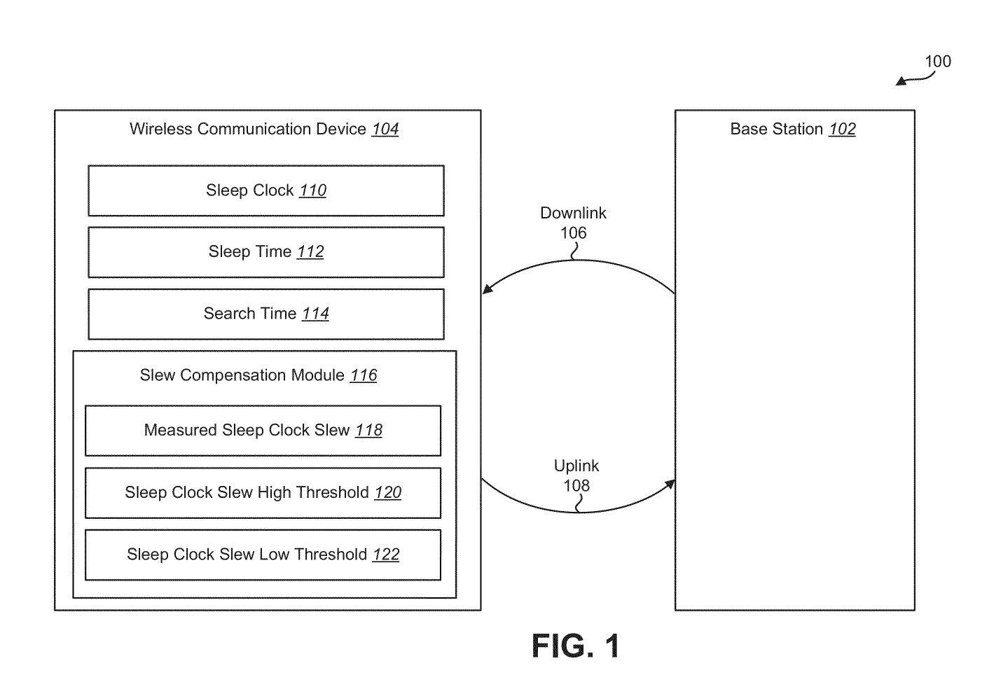

FIG. 1 shows a wireless communication system 100 with multiple wireless devices. Wireless communication systems 100 are widely deployed to provide various types of communication content such as voice, data and so on. In embodiments of the present invention, a wireless device may be a base station or a wireless communication device.

A base station 102 is a station that communicates with one or more wireless communication devices 104. A base station 102 may also be referred to as, and may include some or all of the functionality of, an access point, a broadcast transmitter, a NodeB, an evolved NodeB, etc. The term “base station” will be used herein. Each base station 102 provides communication coverage for a particular geographic area. A base station 102 may provide communication coverage for one or more wireless communication devices 104. The term “cell” can refer to a base station 102 and/or its coverage area depending on the context in which the term is used.

Communications in a wireless system (e.g., a multiple-access system) may be achieved through transmissions over a wireless link. Such a communication link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may utilize MIMO. A MIMO system may support both time division duplex (TDD) and frequency division duplex (FDD) systems. In a TDD system, uplink 108 and downlink 106 transmissions are on the same frequency region so that the reciprocity principle allows the estimation of the downlink 106 channel from the uplink 108 channel. This enables a transmitting wireless device to extract transmit beamforming gain from communications received by the transmitting wireless device.

The wireless communication system 100 may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO), single-carrier frequency division multiple access (SC-FDMA) systems, 3^{rd} Generation Partnership Project (3GPP) Long Term Evolution (LTE) systems and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA and GSM are part of Universal Mobile Telecommunication System (UMTS). Long Term Evolution (LTE) is a release of UMTS that uses E-UTRA, UTRA, E-UTRA, GSM, UMTS and Long Term Evolution (LTE) are described in documents from an organization named “3rd Generation Partnership Project” (3GPP). cdma2000 is described in documents from an organization named “3rd Generation Partnership Project 2” (3GPP2).

A wireless communication device 104 may also be referred to as, and may include some or all of the functionality of, a terminal, an access terminal, a user equipment (UE), a subscriber unit, a station, etc. A wireless communication device 104 may be a cellular phone, a personal digital assistant (PDA), a wireless device, a wireless modem, a handheld device, a laptop computer, etc.

A wireless communication device 104 may communicate with zero, one or multiple base stations 102 on the downlink 106 and/or uplink 108 at any given moment. The downlink 106 (or forward link) refers to the communication link from a base station 102 to a wireless communication device 104, and the uplink 108 (or reverse link) refers to the communication link from a wireless communication device 104 to a base station 102.

Global Systems for Mobile Communications (GSM) enhanced data rates for GSM evolution (EDGE) (referred to as GERAN) specifications define two modes of operation for a wireless communication device 104 in idle mode: discontinuous reception (DRX) mode and non-DRX mode. In non-DRX mode, the wireless communication device 104 may monitor all the blocks on the common control channel (CCCH) for the wireless communication device 104. In non-DRX mode, the wireless communication device 104 may receive a new assignment message for a downlink 106 data transfer with a minimal delay.

In DRX mode, the wireless communication device 104 may monitor only the radio blocks on the common control channel (CCCH) that correspond to its own paging group. The paging group may be calculated by the wireless communication device 104 and the wireless communication network using the formulae defined in 3GPP TS 45.002. Thus, the wireless communication device 104 may read only one radio block corresponding to the paging index of the wireless communication device 104 every nth 51-multiframe. The parameter n may be 2, 3, 4, 5, 6, 7, 8 or 9, depending on the specific network configuration. The paging index may be calculated by a wireless communication device 104 and by the wireless communication network using the formulae defined in 3GPP TS 45.002. In DRX mode, the wireless communication device 104 may conserve battery power at the expense of a delay before the network can start a downlink 106 data transfer.

At best, in DRX mode the wireless communication device 104 may monitor the paging block corresponding to the paging index of the wireless communication device 104 every 470 milliseconds (ms). At worst, however, in DRX mode the wireless communication device 104 may monitor the paging block corresponding to the paging index of the wireless communication device 104 every 2118 ms. The frequency of the wireless communication device 104 monitoring the paging block may be controlled by broadcast information (assuming SPLIT paging cycle is not used).

In DRX mode, the power consumption of the wireless communication device 104 is dependent on the paging cycle. The paging cycle may cycle between a sleep time 112 and a search time 114. During the sleep time 112, the wireless communication device 104 may not search for pilot signals (e.g., on the paging channel (PCH)). Thus, during sleep time 112, the wireless communication device 104 may conserve battery power. During search time 114, the wireless communication device 104 may actively search for pilot signals.

In embodiments of the present invention, when a wireless communication device 104 is in idle mode, the wireless communication device 104 may switch from using a normal clock to using a sleep clock 110. The sleep clock 110 may consume less power than the normal clock. A sleep clock 110 may slew because of temperature. For example, as phones, dongles and other wireless communication devices 104 grow smaller, heat concentration can cause increases or decreases in the frequency of a sleep clock 110, resulting in the sleep clock 110 becoming desynchronized with clocks on a base station 102. This sleep clock 110 slew may cause the wireless communication device 104 to miss scheduled paging messages and potentially lose connection with a communication network.

The sleep clock 110 slew may affect both the sleep time 112 and search time 114 of the wireless communication device 104 (when the wireless communication device 104 is camped). A large sleep clock 110 slew may increase the power consumption of the wireless communication device 104 and disrupt the DRX mode. Furthermore, if a connection with a communication network is lost, the wireless communication device 104 may have to reacquire a connection with the network, resulting in further disruption to the DRX mode and a significant power consumption impact.

One conventional solution to large sleep clock 110 slew is using expensive sleep crystals (with slews that are more controllable due to temperature variations). However, using sleep crystals may be prohibitively expensive. Another conventional solution is to always use a smaller DRX cycle (e.g., a smaller sleep time 112 and a smaller search time 114). However, this may increase the power consumption of the wireless communication device 104. In yet another conventional solution, the search time 114 may be increased. However, increasing the search time 114 has a power penalty. Furthermore, the search time 114 has a theoretical maximum, depending on the technology. For example, the search time 114 may have a maximum of 576 chips.

The wireless communication device 104 may include a slew compensation module 116. The slew compensation module 116 may allow the wireless communication device 104 to compensate for a large measured sleep clock 110 slew. For example, if the measured sleep clock slew 118 is large, the slew compensation module 116 may increase the search time 114 (thereby increasing the search window size) or decrease the sleep time 112 (thereby decreasing the sleep cycle) for the next DRX wake-up. In one configuration, the slew compensation module 116 may increase the search time 114 or decrease the sleep time 112 until a point is reached where the measured sleep clock slew 118 has reduced. The slew compensation module 116 may then adjust the search time 114 and/or sleep time 112 to compensate for the reduced measured sleep clock slew 118.

The slew compensation module 116 may include a measured sleep clock slew 118. In one configuration, a controller on the wireless communication device 104 may determine the measured sleep clock slew 118 from search errors seen during a DRX mode wake-up. The measured sleep clock slew 118 may thus be only an estimate of the actual sleep clock 110 slew.

The slew compensation module 116 may include a sleep clock slew high threshold 120. During a DRX mode wake-up, the slew compensation module 116 may compare the measured sleep clock slew 118 with the sleep clock slew high threshold 120. If the measured sleep clock slew 118 is higher than the sleep clock slew high threshold 120, the slew compensation module 116 may increase the search time 114 or decrease the sleep time 112. In one configuration, the sleep clock slew high threshold 120 may be the search window size divided by four. For example, the sleep clock slew high threshold 120 may be the search time 114 divided by four.

The slew compensation module 116 may also include a sleep clock slew low threshold 122. During a DRX mode wake-up, the slew compensation module 116 may also compare the measured sleep clock slew 118 with the sleep clock slew low threshold 122. If the measured sleep clock slew 118 is lower than the sleep clock slew low threshold 122, the slew compensation module 116 may decrease the search time 114 or increase the sleep time 112. In one configuration, the sleep clock slew low threshold 122 may be the search window size divided by eight. For example, the sleep clock slew low threshold 122 may be the search time 114 divided by eight.

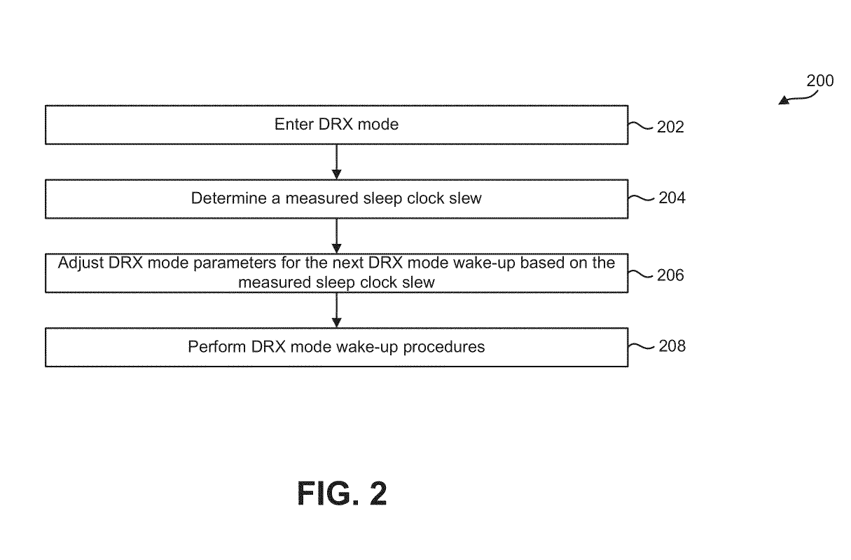

FIG. 2 is a flow diagram of a method 200 of compensating for sleep clock 110 slew in DRX mode. The method 200 may be performed by a wireless communication device 104. The wireless communication device 104 may include a slew compensation module 116. The wireless communication device 104 may enter 202 DRX mode. The wireless communication device 104 may determine 204 a measured sleep clock slew 118. In one configuration, the wireless communication device 104 may determine 204 the measured sleep clock slew 118 as an estimate of the sleep clock 110 slew from search errors seen during a DRX mode wake-up.

The wireless communication device 104 may adjust 206 DRX mode parameters for the next DRX wake-up based on the measured sleep clock slew 118. For example, if the measured sleep clock slew 118 is large, the wireless communication device 104 may increase the search time 114 or decrease the sleep time 112 for the next DRX wake-up (or multiple DRX wake-up cycles). As another example, if the measured sleep clock slew 118 is small, the wireless communication device 104 may decrease the search time 114 or increase the sleep time 112 for the next DRX wake-up (or multiple DRX wake-up cycles). The changes to DRX mode parameters may be applicable only for the next wake-up, since the current wake-up and search has already happened. The wireless communication device 104 may then perform 208 DRX mode wake-up procedures.

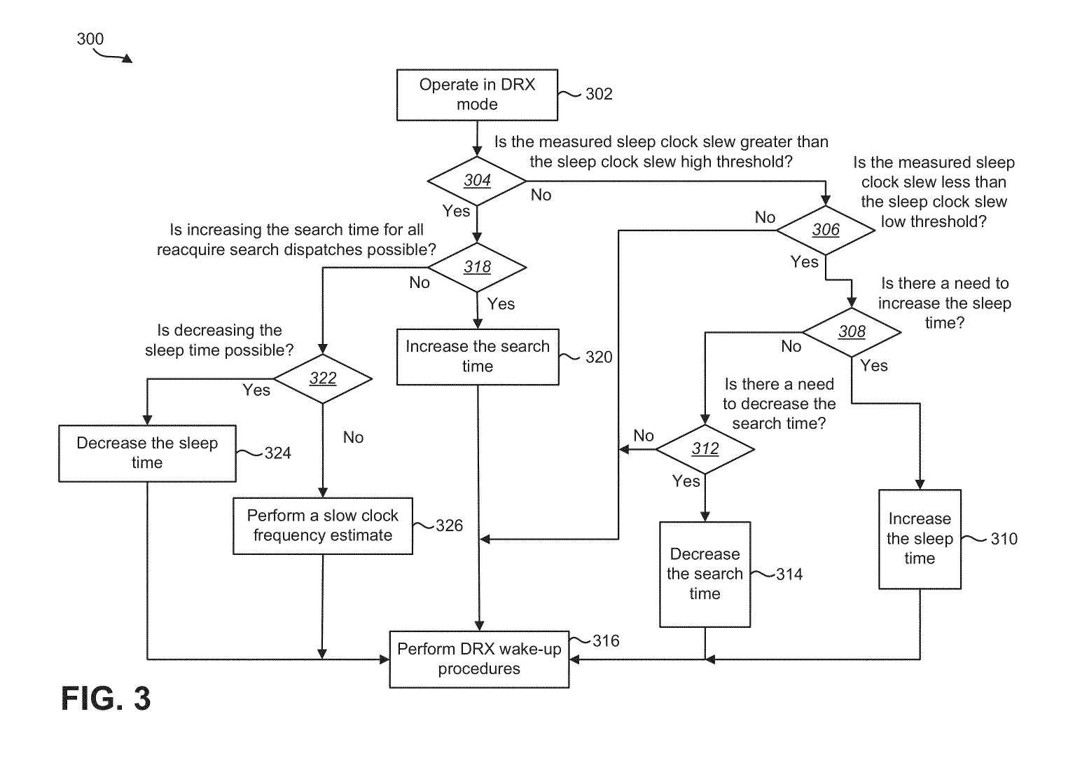

FIG. 3 is a flow diagram of another method 300 of compensating for sleep clock 110 slew in DRX mode. The method 300 may be performed by a wireless communication device 104. The wireless communication device 104 may include a slew compensation module 116. The wireless communication device 104 may operate 302 in DRX mode. The wireless communication device 104 may determine 304 whether the measured sleep clock slew 118 is greater than the sleep clock slew high threshold 120. If the measured sleep clock slew 118 is not greater than the sleep clock slew high threshold 120, the wireless communication device 104 may determine 306 whether the measured sleep clock slew 118 is less than the sleep clock slew low threshold 122.

If the measured sleep clock slew 118 is not less than the sleep clock slew low threshold 122, the wireless communication device 104 may perform 316 DRX wake-up procedures. If the measured sleep clock slew 118 is less than the sleep clock slew low threshold 122, the wireless communication device 104 may determine 308 whether there is a need to increase the sleep time 112. If there is a need to increase the sleep time 112, the wireless communication device 104 may increase 310 the sleep time 112. The wireless communication device 104 may then perform 316 DRX wake-up procedures.

In embodiments of the present invention, if there is not a need to increase the sleep time 112, the wireless communication device 104 may determine 312 whether there is a need to decrease the search time 114. If there is a need to decrease the search time 114, the wireless communication device 104 may decrease 314 the search time. The wireless communication device 104 may then perform 316 DRX wake-up procedures. If there is not a need to decrease the search time 114, the wireless communication device 104 may perform 316 DRX wake-up procedures. Typically the sleep time 112 is increased (if possible) prior to decreasing the search time 114 (if possible) because the sleep time 112 has a much larger impact on the standby current usage than the search time.

If the measured sleep clock slew 118 is greater than the sleep clock slew high threshold 120, the wireless communication device 104 may determine 318 whether increasing the search time 114 for all reacquire search dispatches is possible. If increasing the search time 114 for all reacquire search dispatches is possible, the wireless communication device 104 may increase 320 the search time 114. The wireless communication device 104 may then perform 316 DRX wake-up procedures.

If increasing the search time 114 for all reacquire search dispatches is not possible, the wireless communication device 104 may determine 322 whether decreasing the sleep time 112 is possible. If decreasing the sleep time 112 is not possible, the wireless communication device 104 may perform 326 a slow clock frequency estimate. The slow clock frequency estimate may be 1 second long. The wireless communication device 104 may then perform 316 DRX wake-up procedures. If decreasing the sleep time 112 is possible, the wireless communication device 104 may decrease 324 the sleep time 112. The wireless communication device 104 may then perform 316 DRX wake-up procedures.

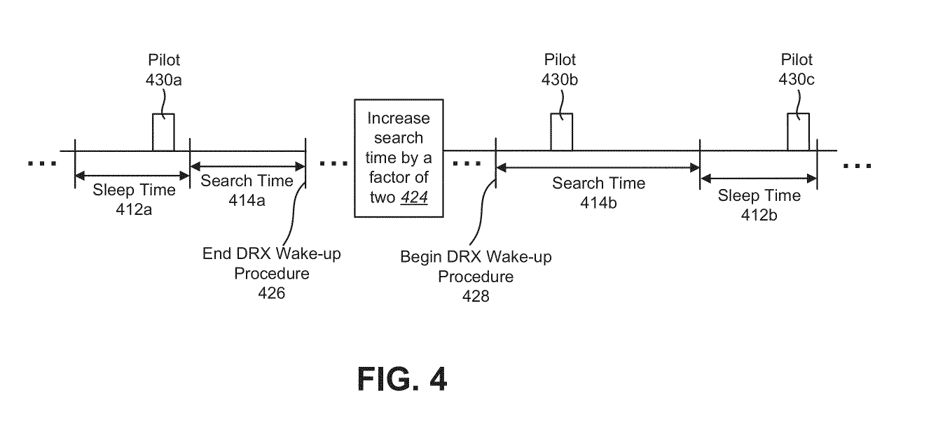

FIG. 4 shows a timing diagram of DRX wake-up procedures for a wireless communication device 104 when the search time 114 is increased. During DRX wake-up procedures, the wireless communication device 104 may sleep for a sleep time 412a and then search for a pilot signal 430a-c during a search time 414a. If the sleep clock 110 slew is large, the wireless communication device 104 may miss the pilot 430 during the DRX wake-up procedure. Missing the pilot 430 may cause the wireless communication device 104 to lose network connections.

After the end 426 of the DRX wake-up procedures, the wireless communication device 104 may increase 424 the search time 114 by a factor of two. The wireless communication device 104 may then begin 428 a DRX wake-up procedure. During the DRX wake-up procedure, the wireless communication device 104 may search for pilots 430 during the search time 414b and then sleep for the sleep time 412b. Because of the large sleep clock 110 slew, the wireless communication device 104 may be more likely to be searching for a pilot 430 when the pilot 430 occurs if the search time 414b has been increased.

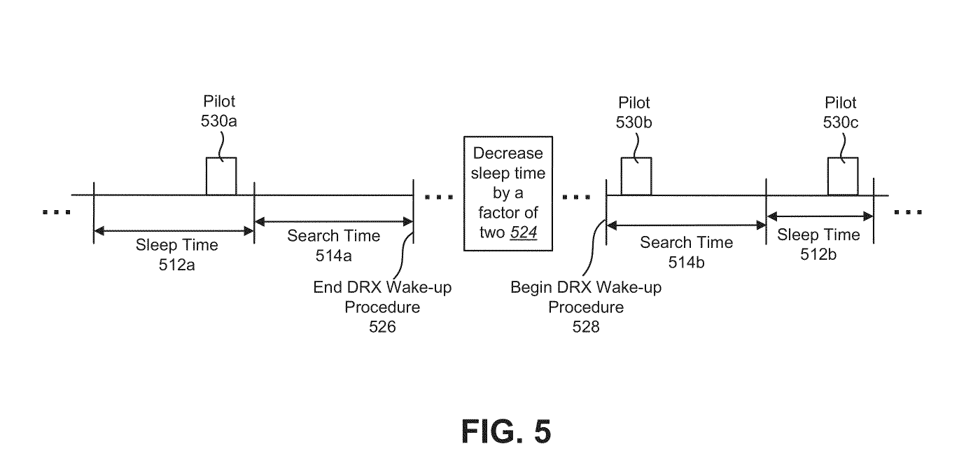

FIG. 5 shows a timing diagram of DRX wake-up procedures for a wireless communication device 104 when the sleep time 112 is decreased. During DRX wake-up procedures, the wireless communication device 104 may sleep for a sleep time 512a and then search for a pilot signal 530a-c during a search time 514a. If the sleep clock 110 slew is large, the wireless communication device 104 may miss the pilot 530a during the DRX wake-up procedure. Missing the pilot 530a may cause the wireless communication device 104 to lose network connections.

After the end 526 of the DRX wake-up procedures, the wireless communication device 104 may decrease 524 the sleep time 112 by a factor of two. The wireless communication device 104 may then begin 528 a DRX wake-up procedure. During the DRX wake-up procedure, the wireless communication device 104 may search for pilots 530 during the search time 514b and then sleep for the sleep time 512b. Because of the large sleep clock 110 slew, the wireless communication device 104 may be more likely to be searching for a pilot 530 when the pilot 530 occurs if the sleep time 512b has been decreased.

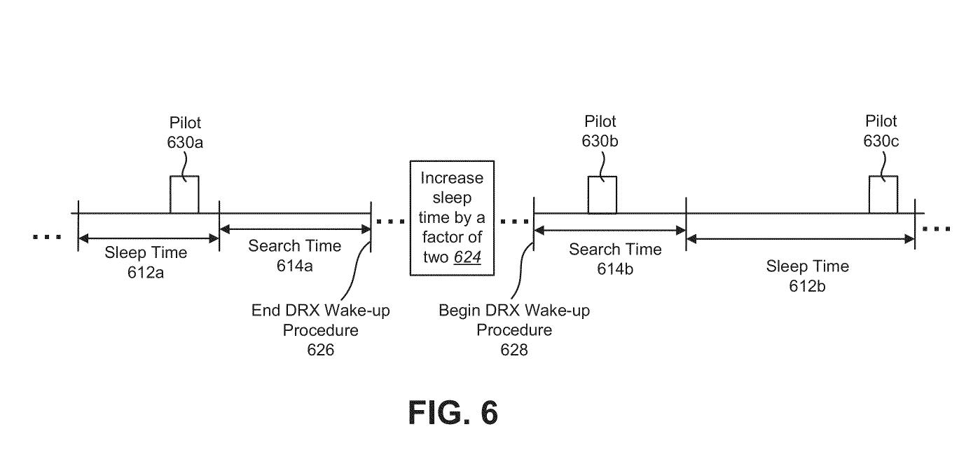

FIG. 6 shows a timing diagram of DRX wake-up procedures for a wireless communication device 104 when the sleep time 112 is increased. During DRX wake-up procedures, the wireless communication device 104 may sleep for a sleep time 612a and then search for a pilot signal 630a-c during a search time 614a. If the sleep clock 110 slew is small, the wireless communication device 104 may conserve battery power by increasing the sleep time 112.

After the end 626 of the DRX wake-up procedures, the wireless communication device 104 may increase 624 the sleep time 112 by a factor of two. The wireless communication device 104 may then begin 628 a DRX wake-up procedure. During the DRX wake-up procedure, the wireless communication device 104 may search for pilots 630 during the search time 614b and then sleep for the sleep time 612b. Because of the small sleep clock 110 slew, the wireless communication device 104 may be likely to be searching for a pilot 630 when the pilot 630 occurs while conserving battery power even though the sleep time 612b has been increased.

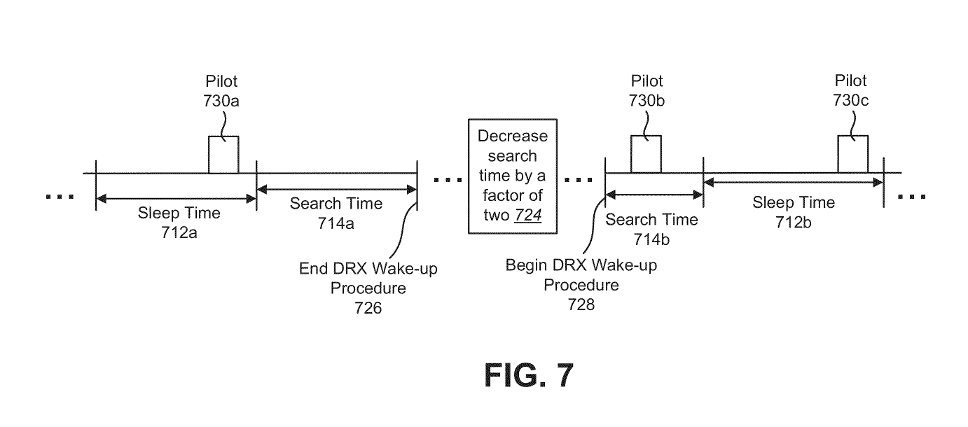

FIG. 7 shows a timing diagram of DRX wake-up procedures for a wireless communication device 104 when the search time 114 is decreased. During DRX wake-up procedures, the wireless communication device 104 may sleep for a sleep time 712a and then search for a pilot 730a-c signal during a search time 714a. If the sleep clock 110 slew is small, the wireless communication device 104 may conserve battery power by decreasing the search time 114.

In embodiments of the present invention, after the end 726 of the DRX wake-up procedures, the wireless communication device 104 may decrease 724 the search time 114 by a factor of two. The wireless communication device 104 may then begin 728 a DRX wake-up procedure. During the DRX wake-up procedure, the wireless communication device 104 may search for pilots 730 during the search time 714b and then sleep for the sleep time 712b. Because of the small sleep clock 110 slew, the wireless communication device 104 may be likely to be searching for a pilot 730 when the pilot 730 occurs while conserving battery power even though the search time 114 has been decreased.

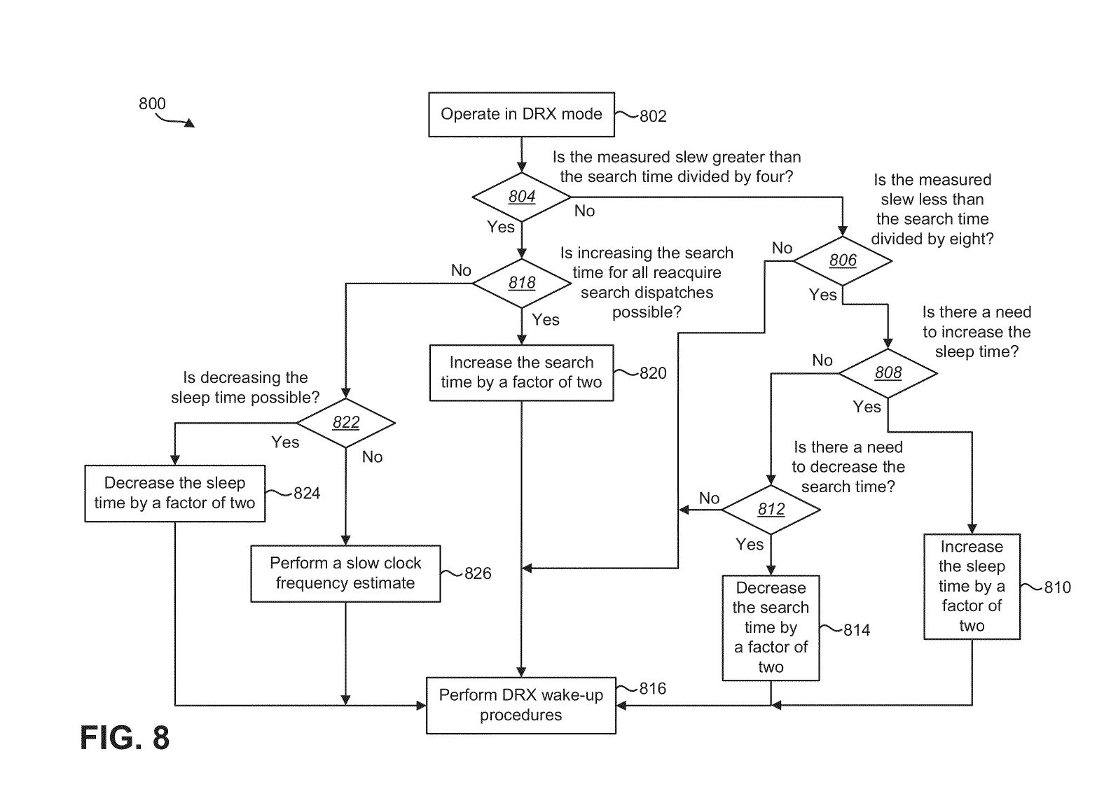

FIG. 8 is a flow diagram of yet another method 800 of compensating for sleep clock 110 slew in DRX mode. The method 800 may be performed by a wireless communication device 104. The wireless communication device 104 may include a slew compensation module 116. The wireless communication device 104 may operate 802 in DRX mode. The wireless communication device 104 may determine 804 whether the measured sleep clock slew 118 is greater than the search time 114 divided by four. If the measured sleep clock slew 118 is not greater than the search time 114 divided by four, the wireless communication device 104 may determine 806 whether the measured sleep clock slew 118 is less than the search time 114 divided by eight.

If the measured sleep clock slew 118 is not less than the search time 114 divided by eight, the wireless communication device 104 may perform 816 DRX wake-up procedures. If the measured sleep clock slew 118 is less than the search time 114 divided by eight, the wireless communication device 104 may determine 808 whether there is a need to increase the sleep time 112. If there is a need to increase the sleep time 112, the wireless communication device 104 may increase 810 the sleep time 112 by a factor of two. The wireless communication device 104 may then perform 816 DRX wake-up procedures.

If there is not a need to increase the sleep time 112, the wireless communication device 104 may determine 812 whether there is a need to decrease the search time 114. If there is a need to decrease the search time 114, the wireless communication device 104 may decrease 814 the search time 114 by a factor of two. The wireless communication device 104 may then perform 816 DRX wake-up procedures. If there is not a need to decrease the search time 114, the wireless communication device 104 may perform 816 DRX wake-up procedures.

If the measured sleep clock slew 118 is greater than the search time 114 divided by four, the wireless communication device 104 may determine 818 whether increasing the search time 114 for all reacquire search dispatches is possible. If increasing the search time 114 for all reacquire search dispatches is possible, the wireless communication device 104 may increase 820 the search time 114 by a factor of two. The wireless communication device 104 may then perform 816 DRX wake-up procedures.

If increasing the search time 114 for all reacquire search dispatches is not possible, the wireless communication device 104 may determine 822 whether decreasing the sleep time 112 is possible. If decreasing the sleep time 112 is not possible, in embodiments of the present invention, the wireless communication device 104 may perform 826 a slow clock frequency estimate. The slow clock frequency estimate may be 1 second long. The wireless communication device 104 may then perform 816 DRX wake-up procedures. If decreasing the sleep time 112 is possible, the wireless communication device 104 may decrease 824 the sleep time 112 by a factor of two. The wireless communication device 104 may then perform 816 DRX wake-up procedures.

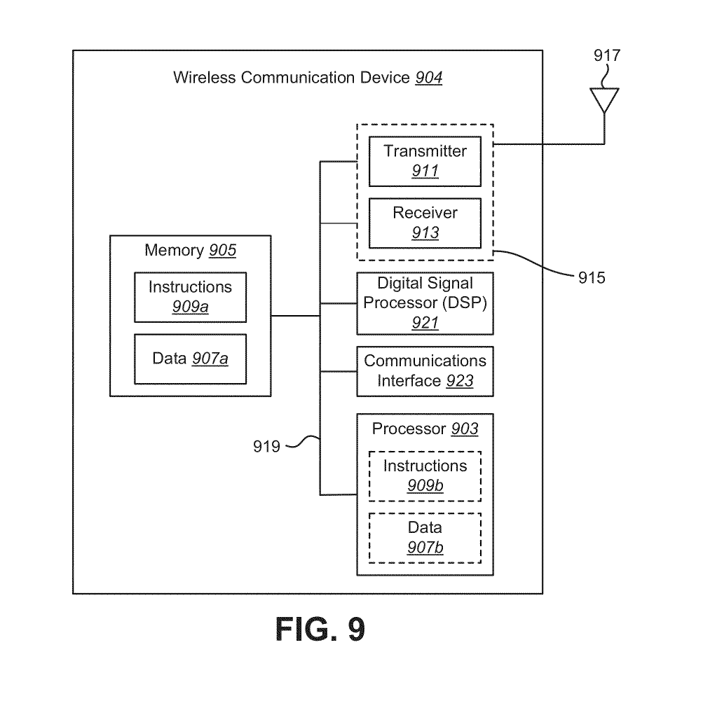

FIG. 9 illustrates certain components that may be included within a wireless communication device 904. The wireless communication device 904 may be an access terminal, a mobile station, a user equipment (UE), etc. The wireless communication device 904 includes a processor 903. The processor 903 may be a general purpose single- or multi-chip microprocessor (e.g., an ARM), a special purpose microprocessor (e.g., a digital signal processor (DSP)), a microcontroller, a programmable gate array, etc. The processor 903 may be referred to as a central processing unit (CPU). Although just a single processor 903 is shown in the wireless communication device 904 of FIG. 9, in an alternative configuration, a combination of processors 903 (e.g., a general purpose CPU and digital signal processor (DSP)) could be used.

The wireless communication device 904 also includes memory 905. The memory 905 may be any electronic component capable of storing electronic information. The memory 905 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 907a and instructions 909a may be stored in the memory 905. The instructions 909a may be executable by the processor 903 to implement the methods disclosed herein. Executing the instructions 909a may involve the use of the data 907a that is stored in the memory 905. When the processor 903 executes the instructions 909a, various portions of the instructions 909b may be loaded onto the processor 903, and various pieces of data 907b may be loaded onto the processor 903.

The wireless communication device 904 may also include a transmitter 911 and a receiver 913 to allow transmission and reception of signals to and from the wireless communication device 904. The transmitter 911 and receiver 913 may be collectively referred to as a transceiver 915. An antenna 917 may be electrically coupled to the transceiver 915. The wireless communication device 904 may also include (not shown) multiple transmitters, multiple receivers, multiple transceivers and/or multiple antennas.

The wireless communication device 904 may include a digital signal processor (DSP) 921. The wireless communication device 904 may also include a communications interface 923. The communications interface 923 may allow a user to interact with the wireless communication device 904.

The various components of the wireless communication device 904 may be coupled together by one or more buses 919, which may include a power bus, a control signal bus, a status signal bus, a data bus, etc. For the sake of clarity, the various buses are illustrated in FIG. 9 as a bus system 919.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 2, 3 and 8, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

We claim:

1. A method for compensating for sleep clock slew, comprising:
operating in a discontinuous receive mode;
determining a measured sleep clock slew;
adjusting discontinuous receive mode parameters based on the measured sleep clock slew; and
performing discontinuous receive mode wake-up procedures.

2. The method of claim 1, wherein the discontinuous receive mode parameters comprise a sleep time for discontinuous receive mode.

3. The method of claim 1, wherein the discontinuous receive mode parameters comprise a search time for discontinuous receive mode.

4. The method of claim 1, further comprising determining whether the measured sleep clock slew is greater than a sleep clock slew high threshold.

5. The method of claim 4, wherein the sleep clock slew high threshold is a search time divided by four.

6. The method of claim 4, wherein the measured sleep clock slew is not greater than the sleep clock slew high threshold, and further comprising determining whether the measured sleep clock slew is less than a sleep clock slew low threshold.

7. The method of claim 6, wherein the sleep clock slew low threshold is a search time divided by eight.

8. The method of claim 6, wherein the measured sleep clock slew is less than the sleep clock slew low threshold, and further comprising determining whether there is a need to increase a sleep time.

9. The method of claim 8, wherein there is a need to increase the sleep time, and wherein adjusting discontinuous receive mode parameters comprises increasing the sleep time.

10. The method of claim 9, wherein the sleep time is increased by a factor of two.

11. The method of claim 8, wherein there is not a need to increase the sleep time, and further comprising determining whether there is a need to decrease a search time.

12. The method of claim 11, wherein there is a need to decrease the search time, and wherein adjusting discontinuous receive mode parameters comprises decreasing the search time.

13. The method of claim 12, wherein the search time is decreased by a factor of two.

14. The method of claim 4, wherein the measured sleep clock slew is greater than the sleep clock slew high threshold, and further comprising determining whether increasing a search time for all reacquire search dispatches is possible.

15. The method of claim 14, wherein it is determined that increasing the search time for all reacquire search dispatches is possible, and wherein adjusting discontinuous receive mode parameters comprises increasing the search time.

16. The method of claim 15, wherein the search time is increased by a factor of two.

17. The method of claim 14, wherein it is determined that increasing the search time for all reacquire search dispatches is not possible, and further comprising determining whether decreasing a sleep time is possible.

18. The method of claim 17, wherein it is determined that increasing the sleep time is possible, and wherein adjusting discontinuous receive mode parameters comprises increasing the sleep time.

19. The method of claim 18, wherein the sleep time is increased by a factor of two.

20. The method of claim 17, wherein it is determined that increasing the sleep time is not possible, and further comprising performing a slow clock frequency estimate.

21. The method of claim 1, wherein the method is performed by a wireless communication device.

22. An apparatus configured for compensating for sleep clock slew, comprising:
a processor;
memory in electronic communication with the processor; and
instructions stored in the memory, the instructions being executable by the processor to:
operate in a discontinuous receive mode;
determine a measured sleep clock slew;
adjust discontinuous receive mode parameters based on the measured sleep clock slew; and
perform discontinuous receive mode wake-up procedures.

23. The apparatus of claim 22, wherein the discontinuous receive mode parameters comprise a sleep time for discontinuous receive mode.

24. The apparatus of claim 22, wherein the discontinuous receive mode parameters comprise a search time for discontinuous receive mode.

25. The apparatus of claim 22, wherein the instructions are further executable to determine whether the measured sleep clock slew is greater than a sleep clock slew high threshold.

26. The apparatus of claim 25, wherein the sleep clock slew high threshold is a search time divided by four.

27. The apparatus of claim 25, wherein the measured sleep clock slew is not greater than the sleep clock slew high threshold, and wherein the instructions are further executable to determine whether the measured sleep clock slew is less than a sleep clock slew low threshold.

28. The apparatus of claim 27, wherein the sleep clock slew low threshold is a search time divided by eight.

29. The apparatus of claim 27, wherein the measured sleep clock slew is less than the sleep clock slew low threshold, and wherein the instructions are further executable to determine whether there is a need to increase a sleep time.

30. The apparatus of claim 29, wherein there is a need to increase the sleep time, and wherein the instructions executable to adjust discontinuous receive mode parameters comprise instructions executable to increase the sleep time.

31. The apparatus of claim 30, wherein the sleep time is increased by a factor of two.

32. The apparatus of claim 29, wherein there is not a need to increase the sleep time, and wherein the instructions are further executable to determine whether there is a need to decrease a search time.

33. The apparatus of claim 32, wherein there is a need to decrease the search time, and wherein the instructions executable to adjust discontinuous receive mode parameters comprise instructions executable to decrease the search time.

34. The apparatus of claim 33, wherein the search time is decreased by a factor of two.

35. The apparatus of claim 25, wherein the measured sleep clock slew is greater than the sleep clock slew high threshold, and wherein the instructions are further executable to determine whether increasing a search time for all reacquire search dispatches is possible.

36. The apparatus of claim 35, wherein it is determined that increasing the search time for all reacquire search dispatches is possible, and wherein the instructions executable to adjust discontinuous receive mode parameters comprise instructions executable to increase the search time.

37. The apparatus of claim 36, wherein the search time is increased by a factor of two.

38. The apparatus of claim 35, wherein it is determined that increasing the search time for all reacquire search dispatches is not possible, and wherein the instructions are further executable to determine whether decreasing a sleep time is possible.

39. The apparatus of claim 38, wherein it is determined that increasing the sleep time is possible, and wherein the instructions executable to adjust discontinuous receive mode parameters comprise instructions executable to increase the sleep time.

40. The apparatus of claim 39, wherein the sleep time is increased by a factor of two.

41. The apparatus of claim 38, wherein it is determined that increasing the sleep time is not possible, and wherein the instructions are further executable to perform a slow clock frequency estimate.

42. The apparatus of claim 22, wherein the apparatus is a wireless communication device.

43. A computer-program product configured for compensating for sleep clock slew, the computer-program product comprising a non-transitory computer-readable medium having instructions thereon, the instructions comprising:
code for causing a wireless device to operate in a discontinuous receive mode;
code for causing the wireless device to determine a measured sleep clock slew;
code for causing the wireless device to adjust discontinuous receive mode parameters based on the measured sleep clock slew; and
code for causing the wireless device to perform discontinuous receive mode wake-up procedures.

44. The computer-program product of claim 43, wherein the code for causing the wireless device to adjust discontinuous receive mode parameters comprises code for causing the wireless device to increase a sleep time by a factor of two.

45. The computer-program product of claim 43, wherein the code for causing the wireless device to adjust discontinuous receive mode parameters comprises code for causing the wireless device to decrease a search time by a factor of two.
